(19) United States
(12) Patent Application Publication
(10) Pub. No.: US 2009/0135854 A1
(43) Pub. Date: May 28, 2009

(54) SYSTEM AND METHOD FOR CLOCK SYNCHRONIZATION

(76) Inventors: Mark Bettin, Murphy, TX (US); Philip Buchholz, Keller, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/945,412

(22) Filed: Nov. 27, 2007

(51) Int. Cl. H04J 3/06

(52) U.S. Cl. 370/503

(57) ABSTRACT

A system and a method are provided for clock synchronization. The method includes receiving a new transmitter timestamp based upon a transmitter clock, determining a new transmitter timestamp delta between the new transmitter timestamp and a previous transmitter timestamp, determining a new receiver timestamp delta between a new receiver timestamp and a previous receiver timestamp, comparing the new receiver timestamp delta to the new transmitter timestamp delta, and adjusting a receiver clock to minimize a compared difference between the new receiver timestamp delta and the new transmitter timestamp delta. The new receiver timestamp is determined upon reception of the new transmitter timestamp. The previous receiver timestamp is determined upon reception of the previous transmitter timestamp.

### BACKGROUND OF THE INVENTION

1. Field of the Invention

The present invention is generally related to data packet synchronization, and more particularly to a system and method for clock synchronization in which a receiving portion of a system or network is continuously updated to a reference signal from a transmitting portion of the system or network.

2. Discussion of the Background

The process of sampling analog audio, transmitting the audio over a digital network, and converting the audio back to analog audio is difficult. In such a scenario, an audio digital-to-analog (“D/A”) converter at a receiver is run at a fixed rate, and the rate at which the audio data is read from a storage device, streaming audio server or the like, is varied to prevent data over-run or under-run at the audio D/A converter. In a packet-based network application, the sample rate of the source of the audio data (e.g., an audio analog-to-digital (“A/D”) converter) cannot be changed, therefore the audio data sink (e.g., an audio D/A converter) must be exactly speed-matched to the source without the benefit of feedback information from the receiver to the source. As such, synchronization issues between the receiver and the source may exist.

Thus, as noted above, there currently exists deficiencies in data packet synchronization in the prior art.

### SUMMARY OF THE INVENTION

Accordingly, one aspect of the present invention is to provide a method for clock synchronization. The method includes receiving a new transmitter timestamp based upon a transmitter clock, determining a new transmitter timestamp delta between the new transmitter timestamp and a previous transmitter timestamp, determining a new receiver timestamp delta between a new receiver timestamp and a previous receiver timestamp, comparing the new receiver timestamp delta to the new transmitter timestamp delta, and adjusting a receiver clock to minimize a compared difference between the new receiver timestamp delta and the new transmitter timestamp delta. The new receiver timestamp is determined upon reception of the new transmitter timestamp. The previous receiver timestamp is determined upon reception of the previous transmitter timestamp.

Another aspect of the present invention is to provide a system for clock synchronization. The system includes a receiver counter configured to determine a number of clock cycles of a receiver clock, and a comparator communicably connected to the receiver counter. The comparator is configured to detect a new transmitter timestamp based upon a transmitter clock, determine a new transmitter timestamp delta between the new transmitter timestamp and a previous transmitter timestamp, detect a new receiver timestamp provided by the receiver counter that corresponds to the reception of the new transmitter timestamp, determine a new receiver timestamp delta between the new receiver timestamp and a previous receiver timestamp, and compare the new receiver timestamp delta to the new transmitter timestamp delta. The previous receiver timestamp is determined upon reception of the previous transmitter timestamp.

Yet another aspect of the present invention is to provide a system for clock synchronization. The system includes a transmitter configured to transmit a new transmitter timestamp based upon a transmitter clock, a receiver configured to receive the new transmitter timestamp, a receiver counter configured to determine a number of clock cycles received from a receiver clock, a comparator, and a terminal count generator communicably connected to the comparator. The receiver counter is communicably connected to the receiver. The comparator is configured to detect a new transmitter timestamp based upon the transmitter clock, determine a new transmitter timestamp delta between the new transmitter timestamp and a previous transmitter timestamp, detect a new receiver timestamp provided by the receiver counter that corresponds to the reception of the new transmitter timestamp, determine a new receiver timestamp delta between the new receiver timestamp and a previous receiver timestamp, and compare the new receiver timestamp delta to the new transmitter timestamp delta. The comparator is communicably connected to the receiver counter. The terminal count generator adjusts the receiver clock to minimize a compared difference between the new receiver timestamp delta and the new transmitter timestamp delta.

Another aspect of the present invention is to provide a system for synchronizing a sample clock frequency between a video and/or audio transmitter and a video and/or audio receiver. The system includes a transmitter, and a receiver communicably connected over a digital packet network to the transmitter. A clock frequency on the transmitter is similar to a clock frequency on the receiver. The transmitter includes a free-running counter configured to receive a clock, count to a maximum count and then roll over, and send a first value of the free-running counter to the receiver. The receiver includes a first module, a second module and a divider. The first module is configured to receive the first value of the free-running counter and a first timestamp associated with the first value, receive a second value of the free-running counter and a second timestamp associated with the second value, compare the first timestamp and the second timestamp to produce a first variable, and compare the first value and the second value to produce a second variable. The second module is configured to adjust the clock speed based upon the first variable and the second variable. The divider is adjusted to minimize a difference between the first variable and the second variable.

Yet another aspect of the present invention is to provide a system for synchronizing a sample clock frequency between a video and/or audio transmitter and a video and/or audio receiver. The system includes a first module, a second module and a divider. The first module is configured to receive a first value of a free-running counter and a first timestamp associated with the first value, receive a second value of the free-running counter and a second timestamp associated with the second value, compare the first timestamp and the second timestamp to produce a first variable, compare the first value and the second value to produce a second variable. The second module is configured to slow the clock when the second variable is greater than the first variable, and speed the clock when the second variable is less than the first variable. The divider is adjusted to minimize a difference between the first variable and the second variable.

Another aspect of the present invention is to provide a system for synchronizing a clock frequency between a transmitter and a receiver. The system includes a first module, and a second module communicably connected to the first module. The first module is configured to receive a first value of a counter and a first timestamp associated with the first value, receive a second value of the counter and a second timestamp associated with the second value, compare the first timestamp and the second timestamp to produce a first variable, compare the first value and the second value to produce a second variable. The second module is configured to slow the clock when the second variable is greater than the first variable, and speed the clock when the second variable is less than the first variable.

Yet another aspect of the present invention is to provide a method for clock synchronization. The method includes receiving a new transmitter timestamp, determining a new transmitter timestamp delta between the new transmitter timestamp and a previous transmitter timestamp, determining a new receiver timestamp delta between a new receiver timestamp and a previous receiver timestamp, comparing the new receiver timestamp delta to the new transmitter timestamp delta, and adjusting a receiver clock based on the comparing.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1A is a block diagram illustrating a system for clock synchronization in accordance with an embodiment of the present invention;

FIG. 1B is a block diagram illustrating one possible implementation of the system shown in FIG. 1A in accordance with an embodiment of the present invention;

FIG. 2 is a flow chart illustrating a method for clock synchronization in accordance with an embodiment of the present invention;

FIG. 3 is a flow chart illustrating a second method for clock synchronization in accordance with an embodiment of the present invention;

FIG. 4 is a flow chart illustrating a third method for clock synchronization in accordance with an embodiment of the present invention;

FIG. 5 is a flow chart illustrating a fourth method for clock synchronization in accordance with an embodiment of the present invention;

FIG. 6 is a flow chart illustrating a fifth method for clock synchronization in accordance with an embodiment of the present invention;

FIG. 7 is a flow chart illustrating a sixth method for clock synchronization in accordance with an embodiment of the present invention; and

FIG. 8 is a flow chart illustrating a seventh method for clock synchronization of a network in accordance with an embodiment of the present invention.

### DETAILED DESCRIPTION THE PREFERRED EMBODIMENTS

Referring now to the drawings, wherein like reference numerals designate identical or corresponding parts throughout the several views, preferred embodiments of the present invention are described.

Transmissions of audio over a packet-based network typically require digitizing the analog audio signal (from audio input connectors) on a transmitter board, packetizing the data, sending the data over a network to a receiver board, de-packetizing the data and then converting the data back to the analog audio signal for line-level outputs. A device or program capable of performing encoding and decoding a digital data stream or signal is referred to as a Compressor-Decompressor (“codec”). In order to transmit audio in this manner, the frequency of an audio codec on the transmitter board must be perfectly synchronized to the frequency of an audio codec on the receiver board. In a packet-based transmission system, there is no way to transmit the audio sampling clock to the receiver, so the sampling clock must be replicated in the receiver.

The present invention allows for the precise frequency replication of the transmitter audio sampling clock in the receiver. The present invention further provides a reference clock synchronization of a wired or wireless network that allows data packets to be continuously, or at least substantially continuously, synchronized to a reference signal. As such, the precise frequency locking of a reference clock between any two components over a packet-based digital network can be accomplished without using out-of-band or out-of-channel signals. The present invention allows for many different audio sampling frequencies to be used over a digital packet network that has a fixed transmission frequency and allows for different packet-based network transmitter/receiver pairs to be synchronized using different reference clock frequencies within the same network topology.

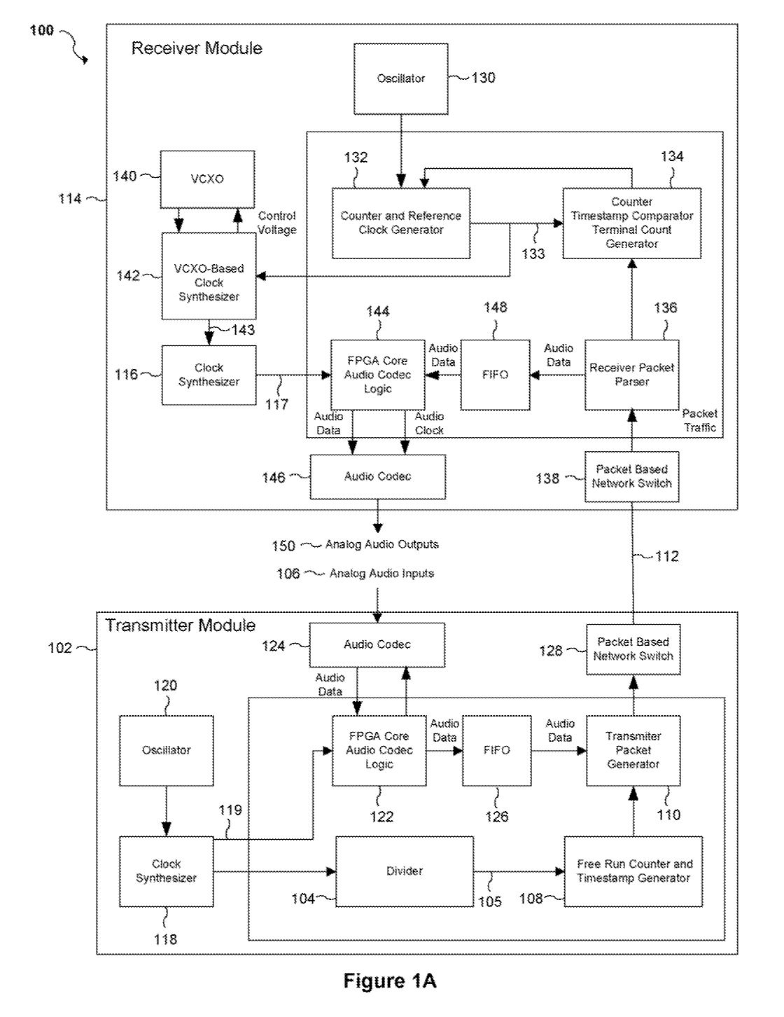

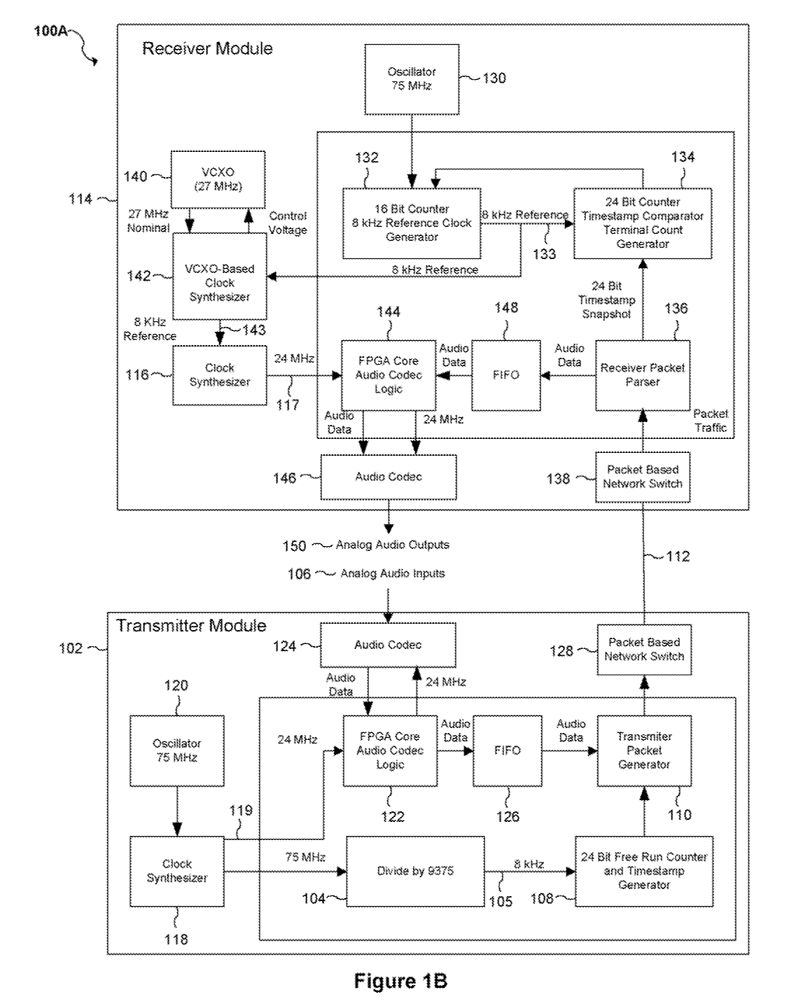

Referring to FIG. 1A, a block diagram illustrating a system for clock synchronization in accordance with an embodiment of the present invention is shown. A transmitter or transmitter module 102 includes a clock synthesizer 118 that is used to digitally sample an analog audio signal 106 and to drive a counter 108. According to one possible implementation, as shown in FIG. 1B, the counter 108 is a 24-bit free-running counter. However, other types of counters are within the scope of the present invention. The digitized audio data is packetized by a packet generator 110 and sent over a connection 112 to a receiver or receiver module 114. Connection 112 includes, but is not limited to, a packet-based connection over a digital packet network, a connection over a network, another switch or the like.

A timestamp snapshot of the counter 108 is taken at periodic intervals and is then sent to the receiver 114. According to one embodiment, the timestamp snapshot of the counter 108 is taken at sufficiently long intervals (e.g., around 1 second) so as not to produce significant network traffic. However, other periodic intervals are possible within the scope of the present invention. The receiver 114 receives the timestamp, which is used to generate an audio sample clock 117 in the receiver with the same or substantially the same frequency as the reference clock in the transmitter 102. This audio sample clock 117, along with the received digital audio data, is used to reconstruct the original analog audio signal and to reduce, if not eliminate, the possibility of data over-runs or data under-runs within various first-in-first-out (“FIFO”) modules 126, 148 used in the digital audio data.

An oscillator 120 in the transmitter 102 drives a clock synthesizer 118 which generates an audio sample clock 119. According to one possible implementation, as shown in FIG. 1B, the oscillator 120 is a 75 MHz oscillator and the clock synthesizer 118 generates a 24 MHz audio sample clock. In other embodiments of the present invention, the oscillator 120 may operate at a frequency other than 75 MHz and the clock synthesizer 118 generates frequencies other than 24 MHz. The audio sample clock 119 generated from the clock synthesizer 118 drives an audio codec interface logic 122 in a field programmable gate array (“FPGA”), and an audio codec module 124, which samples the analog audio signal 106.

The digitized audio data from the audio codec 124 is received by the audio codec interface logic 122 in the FPGA, which synchronizes the digital audio data to the transmitter clock domain by using a FIFO 126. The transmitter 102 packetizes the data and sends the data packets to the receiver 114 via a network switch 128. The oscillator 120 in the transmitter 102 drives the clock synthesizer 118, which then drives a clock divider 104 in the FPGA, which produces a reference clock 105, which in turn drives a counter 108 (which is initialized to zero at power-up). According to one possible implementation, as shown in FIG. 1B, the clock divider 104 divides by 9375 and produces an 8 kHz reference clock 105, which in turn drives a 24-bit free-running counter 108. The transmitter 102 periodically takes a snapshot of the counter 108 (e.g., once per second), packetizes the count into a small timestamp packet, and sends the timestamp to the receiver 114. In other embodiments of the present invention, the snapshot of the 24-bit count can occur more or less than once per second, and may occur in different timeframes than once per second. Further, the clock divider may divide by other values within the scope of other embodiments of the present invention.

A oscillator 130 in the receiver 114 drives a counter 132 that initially starts at zero. The counter or reference clock 132 counts up to a terminal count (“TC”), resets to zero, and starts counting up again. The reference clock 132 drives a counter or timestamp comparator 134.

According to one possible implementation, as shown in FIG. 1B, the oscillator 130 is a 75 MHz oscillator which drives a 16-bit counter 132. At power-up, or after a reset, the TC input is set to 9375 (which produces a nominal output clock of 8 kHz), and the 8 kHz reference clock 132 output is set high. At a count of TC/2, the 8 kHz reference clock 132 output is set low. At the count of TC, the 8 kHz reference clock 132 output is set high, the count is set to zero, and the sequence repeats. The 8 kHz reference clock 132 drives a free-running 24-bit counter.

A packet parser 136 of the receiver 114 parses the timestamp from the incoming data stream from the network switch 138 and sends the latest timestamp to the timestamp comparator 134.

According to one possible implementation, as shown in FIG. 1B, the latest timestamp is a 24-bit timestamp. When the first timestamp comes in after power-up, the timestamp comparator 134 takes a snapshot of the free-running 24-bit counter and saves that count along with the 24-bit timestamp. When the next 24-bit timestamp comes in to the receiver, another snapshot is taken of the free-running 24-bit counter and that value is saved along with the 24-bit timestamp.

At this point the difference between the first and the second free-running counter snapshots is calculated, and the difference between the first and the second timestamps is calculated. If the differences match, then it is assumed that the audio sample clocks on the transmitter 102 and receiver 114 are at the same frequency. If the differences are not the same, then the terminal count value is either incremented or decremented to cause the 8 kHz jittery reference clock 133 to either slow down or speed up, respectively. The term “jittery” is used to represent a frequency that changes, and possibly significantly changes, over a relatively short period of time. This in turn slows down or speeds up the free-running counter 134, so as to make the differences match the next time a snapshot of the free-running counter is taken. According to one possible implementation, as shown in FIG. 1B, free-running counter 134 is a free-running 24-bit counter. The difference calculation is used so that the free-running counter 134 on the receiver 114 does not have to be synchronized, from a count-value perspective, to the free-running counter 108 on the transmitter 102 when the first timestamp packet is received. According to one possible implementation, as shown in FIG. 1B, free-running counter 108 is a free-running 24-bit counter.

As such timestamps are received, the second snapshot values become the first snapshot values, a new second snapshot of the free-running counter 134 is taken, new difference calculations are done, and the terminal count is adjusted accordingly. Averaged over time, the frequency of the reference clock 143 on the receiver 114 will exactly match the frequency of the reference clock 105 on the transmitter 102. However, due to the terminal count corrections made every second (or other timeframe), the reference clock 143 on the receiver 114 will have a very-low-frequency jitter to it. According to one possible implementation, as shown in FIG. 1B, the reference clock 143 is an 8 kHz reference clock and the reference clock 105 is an 8 kHz reference clock.

This low-frequency jitter can be removed according to the present invention. In such a scenario, the jittery reference clock 133 is sent to a voltage-controlled oscillator (VCXO) 140 and VCXO-based clock synchronizer 142 that can be used in various communications applications. According to one possible implementation, as shown in FIG. 1B, the jittery reference clock 133 is an 8 kHz jittery reference clock. The VCXO 140 is a phase locked loop (“PLL”) with a relatively low frequency loop bandwidth, which can filter a jittery input clock into a stable output clock 143. This stable clock 143 drives a clock synthesizer 116 which produces an audio sampling clock 117, which matches or at least substantially matches the frequency of the audio sampling clock 119 on the transmitter 102. According to one possible implementation, as shown in FIG. 1B, audio sampling clock 117 is a 24 MHz audio sampling clock and audio sampling clock 119 is a 24 MHz audio sampling clock.

This clock 117 drives the FPGA audio codec interface logic 144 and also drives the audio codec 146. The audio codec interface logic 144 receives data from the receiver 114 and synchronizes the digital audio data from the network clock domain to the audio codec clock domain using the FIFO module 148. The audio sampling clock 117 and the digital audio data drive the audio codec 146 which re-creates the original analog audio signal 150.

The described and depicted blocks or modules of the system 100 are at least one of software, hardware, and firmware, and/or the combination of at least two of software, hardware, and firmware. The transfer of data between the various blocks or modules in the system 100 occurs via at least one of a wireless protocol, a wired protocol, and/or a combination of a wireless protocol and a wired protocol. The steps performed in the system 100 are performed by at least one of software, hardware, and firmware, and/or the combination of software, hardware, and/or firmware. Additionally, at least one of the system 100, the transmitter 102, the receiver 114, and the described and depicted blocks or modules of the system 100, preferably form a circuit but in certain situations or applications may not.

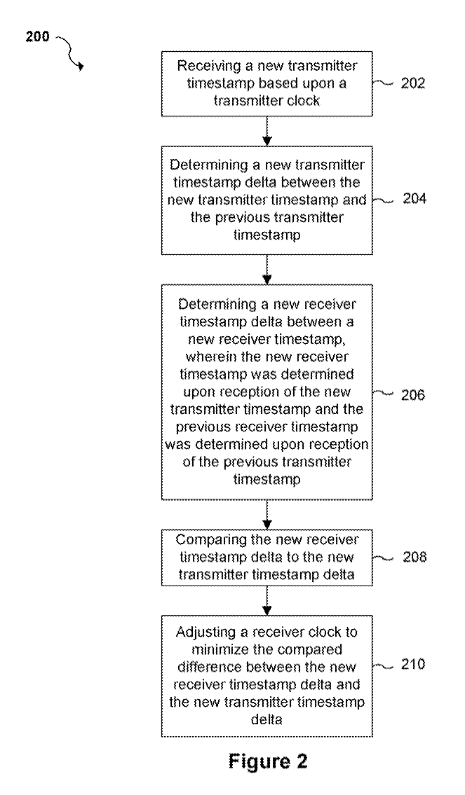

Referring to FIG. 2, a flow chart illustrating a method for clock synchronization in accordance with an embodiment of the present invention is shown. The method includes receiving 202 a new transmitter timestamp based upon a transmitter clock, determining 204 a new transmitter timestamp delta between the new transmitter timestamp and a previous transmitter timestamp, determining 206 a new receiver timestamp delta between a new receiver timestamp and a previous receiver timestamp, comparing 208 the new receiver timestamp delta to the new transmitter timestamp delta, and adjusting 210 a receiver clock to minimize the compared difference between the new receiver timestamp delta and the new transmitter timestamp delta. The new receiver timestamp is determined upon reception of the new transmitter timestamp and the previous receiver timestamp is determined upon reception of the previous transmitter timestamp. The adjusting synchronizes the receiver clock with the transmitter clock. The new transmitter timestamp consists of a transmitter counter value taken at a predetermined interval, where the counter is driven by the transmitter reference clock. According to one possible embodiment, the new transmitter timestamp is based on at least one of an 8 kHz reference clock, less than an 8 kHz reference clock, and greater than an 8 kHz reference clock.

The new transmitter timestamp is provided by a free running counter, is at least one of 24 bits, less than 24 bits, and more than 24 bits, and is packetized. The new receiver timestamp consists of a receiver counter value based on a receiver reference clock. If the new receiver timestamp delta is greater than the new transmitter timestamp delta, the receiver clock is adjusted to be slower by a percentage related to the new transmitter timestamp delta and the new receiver timestamp delta. If the new receiver timestamp delta is less than the new transmitter timestamp delta, the receiver clock is adjusted to be faster by a percentage related to the new transmitter timestamp delta and the new receiver timestamp delta.

The synchronization occurs in at least one of, an optical digital packet-based network, a wired digital packet-based network, and a wireless digital packet-based network. The steps 202-210 performed in FIG. 2 occur via at least one of a wireless protocol, a wired protocol, and a combination of the wireless protocol and the wired protocol, and via at least one of software, hardware, or firmware, and/or the combination of software, hardware, and/or firmware.

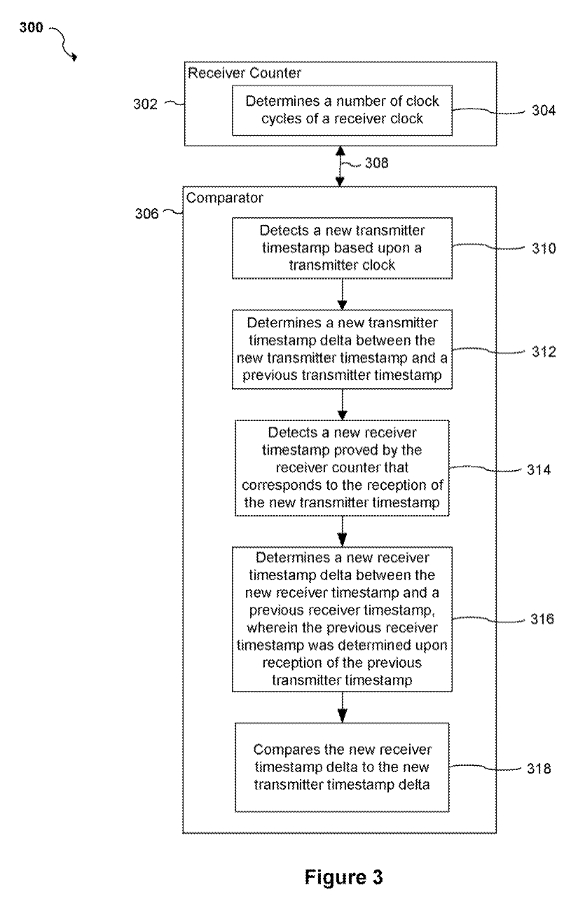

Referring to FIG. 3, a flow chart illustrating a second method for clock synchronization in accordance with an embodiment of the present invention is shown. According to this embodiment, a system 300 for reference clock synchronization includes a receiver counter 302 that determines 304 a number of clock cycles of a receiver clock, and a comparator 306 communicably connected 308 to the receiver counter. The comparator 306 detects 310 a new transmitter timestamp based upon a transmitter clock, determines 312 a new transmitter timestamp delta between the new transmitter timestamp and a previous transmitter timestamp, detects 314 a new receiver timestamp provided by the receiver counter that corresponds to the reception of the new transmitter timestamp, determines 316 a new receiver timestamp delta between the new receiver timestamp and a previous receiver timestamp, and compares 318 the new receiver timestamp delta to the new transmitter timestamp delta. The previous receiver timestamp is determined upon reception of the previous transmitter timestamp.

The described and depicted blocks or modules of the system 300 are at least one of software, hardware, and firmware, and/or the combination of at least two of software, hardware, and firmware. The transfer of data between the various blocks or modules in the system 300 occurs via at least one of a wireless protocol, a wired protocol, and a combination of a wireless protocol and a wired protocol. The steps performed in the system 100 are performed by at least one of software, hardware, and firmware, and/or the combination of software, hardware, and/or firmware. Additionally, at least one of the system 300, the receiver counter 302, the comparator 306, and the described and depicted blocks or modules of the system 300, preferably form a circuit but in certain situations or applications may not.

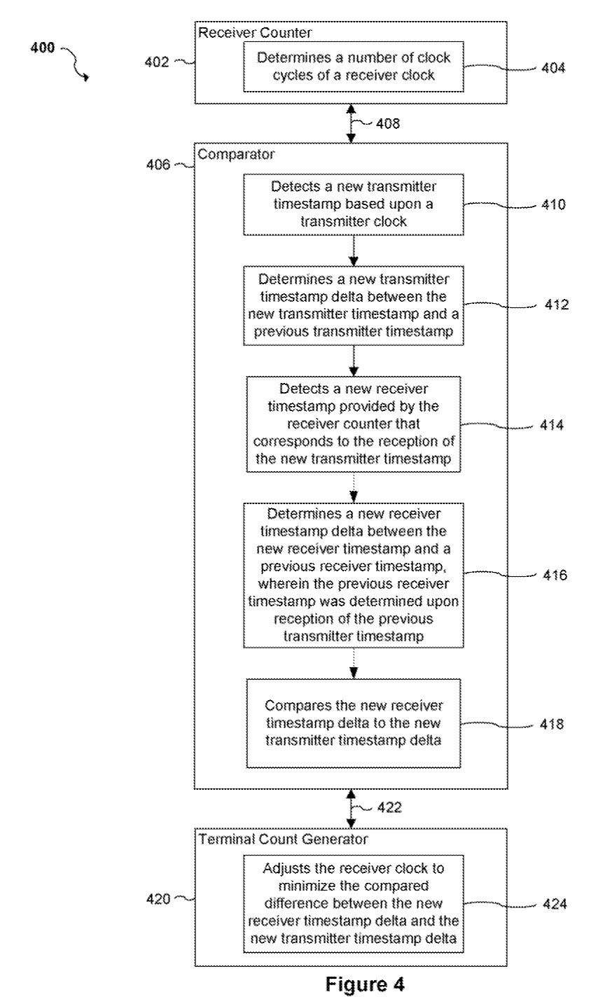

Referring to FIG. 4, a flow chart illustrating a third method for clock synchronization in accordance with an embodiment of the present invention is shown. According to this embodiment a third system 400 for reference clock synchronization includes a receiver counter 402 that determines 404 a number of clock cycles of a receiver clock, and a comparator 406 communicably connected 408 to the receiver counter. The comparator detects 410 a new transmitter timestamp based upon a transmitter clock, determines 412 a new transmitter timestamp delta between the new transmitter timestamp and a previous transmitter timestamp, detects 414 a new receiver timestamp provided by the receiver counter that corresponds to the reception of the new transmitter timestamp, determines 416 a new receiver timestamp delta between the new receiver timestamp and a previous receiver timestamp. The previous receiver timestamp is determined upon reception of the previous transmitter timestamp, and compares 418 the new receiver timestamp delta to the new transmitter timestamp delta.

The system 400 also includes a terminal count generator 420 communicably connected 422 to the comparator 406. The terminal count generator adjusts 424 the receiver clock to minimize the compared difference between the new receiver timestamp delta and the new transmitter timestamp delta, which synchronizes the receiver clock with the transmitter clock. According to one possible embodiment, the receiver counter 402, which is a free running counter that counts to a maximum clock value and then rolls over, includes a receiver clock that is at least one of 1 kHz to 100 kHz, less than 1 kHz, and greater than 100 kHz, and is at least one of 24 bits, less than 24 bits, and more than 24 bits.

The described and depicted blocks or modules of the system 400 are at least one of software, hardware, and firmware, and/or the combination of at least two of software, hardware, and firmware. The transfer of data between the various blocks or modules in the system 400 occurs via at least one of a wireless protocol, a wired protocol, and a combination of a wireless protocol and a wired protocol. The steps performed in the system 400 are performed by at least one of software, hardware, and firmware, and/or the combination of software, hardware, and/or firmware. Additionally, at least one of the system 400, the receiver counter 402, the comparator 406, the terminal count generator 420, and the described and depicted blocks or modules of the system 400, preferably form a circuit but in certain situations or applications may not.

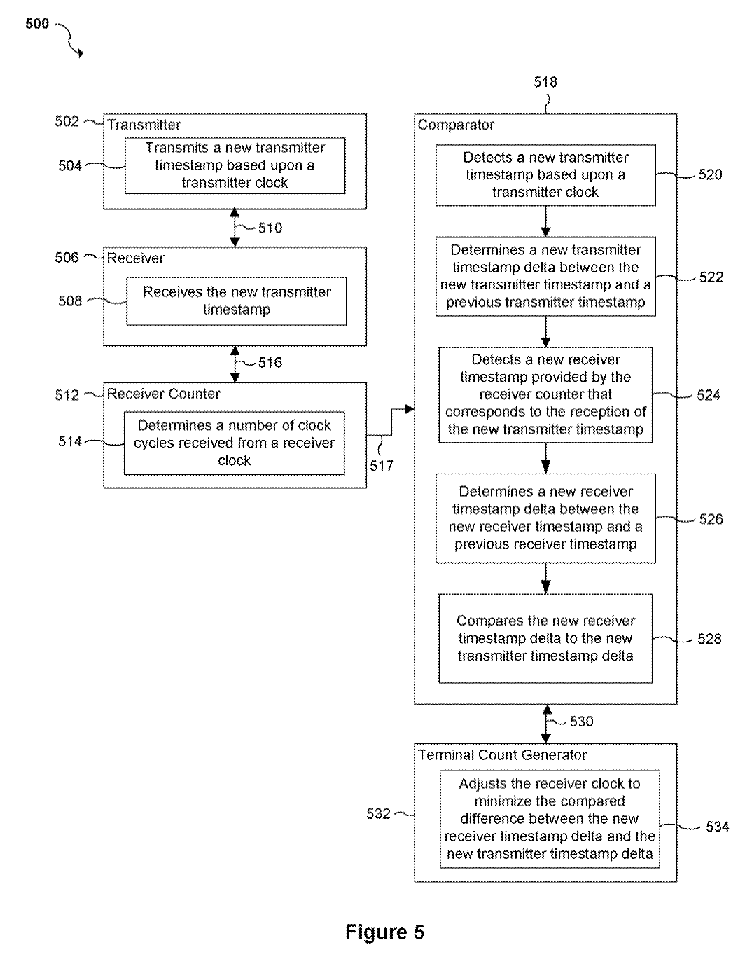

Referring to FIG. 5, a flow chart illustrating a fourth method for clock synchronization in accordance with an embodiment of the present invention is shown. According to this embodiment, a fourth system 500 for reference clock synchronization includes a transmitter 502 that transmits 504 a new transmitter timestamp based upon a transmitter clock, a receiver 506 that receives 508 the new transmitter timestamp, and a receiver counter 512 that determines 514 a number of clock cycles received from a receiver clock. The receiver is communicably connected 510 to the transmitter. The receiver counter is communicably connected 516 to the receiver, and is communicably connected 517 to a comparator 518 that, detects 520 a new transmitter timestamp based upon the transmitter clock, determines 522 a new transmitter timestamp delta between the new transmitter timestamp and a previous transmitter timestamp, detects 524 a new receiver timestamp provided by the receiver counter that corresponds to the reception of the new transmitter timestamp, determines 526 a new receiver timestamp delta between the new receiver timestamp and a previous receiver timestamp, and compares 528 the new receiver timestamp delta to the new transmitter timestamp delta. The comparator 518 is communicably connected 530 to a terminal count generator 532 which adjusts 534 the receiver clock to minimize the compared difference between the new receiver timestamp delta and the new transmitter timestamp delta.

The described and depicted blocks or modules of the system 500 are at least one of software, hardware, and firmware, and/or the combination of at least two of software, hardware, and firmware. The transfer of data between the various blocks or modules in the system 500 occurs via at least one of a wireless protocol, a wired protocol, and a combination of a wireless protocol and a wired protocol. The steps performed in the system 500 are performed by at least one of software, hardware, and firmware, and/or the combination of software, hardware, and/or firmware. Additionally, at least one of the system 500, the transmitter 502, the receiver 506, the receiver counter 512, the comparator 518, the terminal count generator 532, and the described and depicted blocks or modules of the system 500, preferably form a circuit but in certain situations or applications may not.

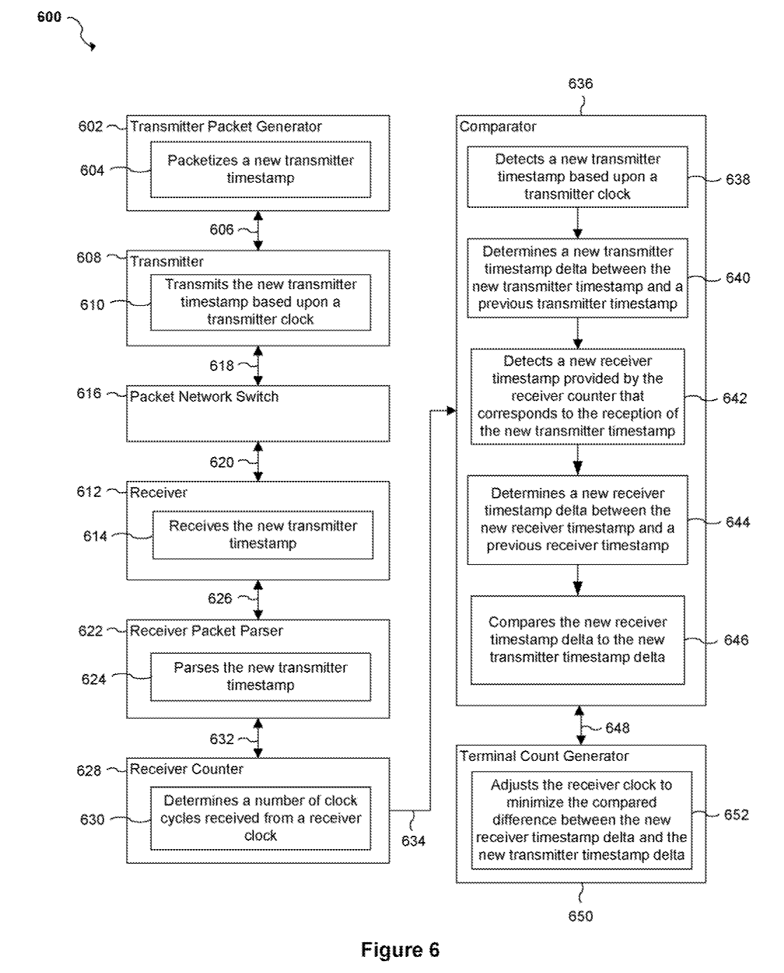

Referring to FIG. 6, a flow chart illustrating a fifth method for clock synchronization in accordance with an embodiment of the present invention is shown. According to this embodiment, a fifth system 600 for reference clock synchronization includes a transmitter packet generator 602 that packetizes 604 a new transmitter timestamp, a receiver 612 that receives 614 the new transmitter timestamp via a digital packet-based network switch 616 communicably connected 618 to the transmitter and communicably connected 620 to the receiver, a receiver packet parser 622 that parses 624 the new transmitter timestamp, and a receiver counter 628 that determines 630 a number of clock cycles received from a receiver clock. The receiver counter is communicably connected 632 to the receiver packet parser. The transmitter packet generator is communicably connected 606 to a transmitter 608 that transmits 610 the new transmitter timestamp based upon a transmitter clock. The receiver packet parser is communicably connected 626 to the receiver

The receiver counter 628 is also communicably connected 634 to a comparator 636 that detects 638 a new transmitter timestamp based upon the transmitter clock, determines 640 a new transmitter timestamp delta between the new transmitter timestamp and a previous transmitter timestamp, detects 642 a new receiver timestamp provided by the receiver counter that corresponds to the reception of the new transmitter timestamp, determines 644 a new receiver timestamp delta between the new receiver timestamp and a previous receiver timestamp, and compares 646 the new receiver timestamp delta to the new transmitter timestamp delta. The comparator is communicably connected 648 to a terminal count generator 650 which adjusts 652 the receiver clock to minimize the compared difference between the new receiver timestamp delta and the new transmitter timestamp delta.

The described and depicted blocks or modules of the system 600 are at least one of software, hardware, and firmware, and/or the combination of at least two of software, hardware, and firmware. The transfer of data between the various blocks or modules in the system 600 occurs via at least one of a wireless protocol, a wired protocol, and a combination of a wireless protocol and a wired protocol. The steps performed in the system 600 are performed by at least one of software, hardware, and firmware, and/or the combination of software, hardware, and/or firmware. Additionally, at least one of the system 600, the transmitter packet generator 602 and the transmitter 608, the receiver 612, the receiver packet parser 622, the receiver counter 628, the comparator 636, the terminal count generator 650, and the described and depicted blocks or modules of the system 600, preferably form a circuit but in certain situations or applications may not.

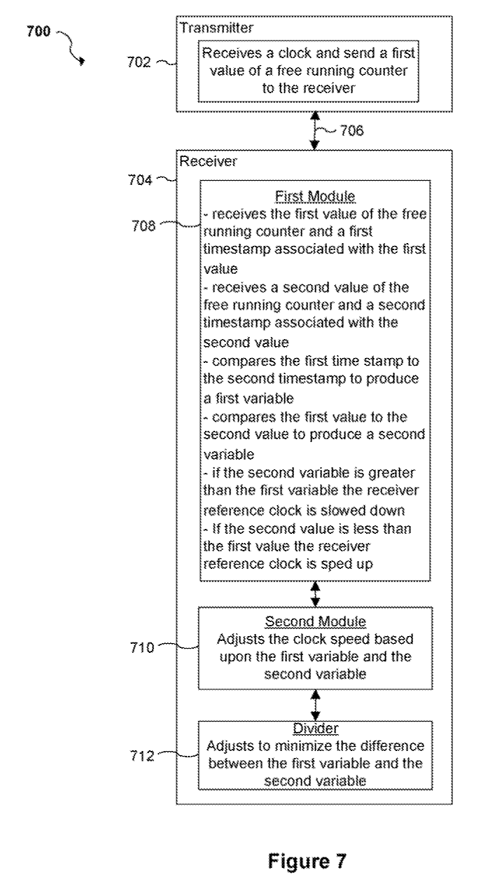

Referring to FIG. 7, a flow chart illustrating a sixth method for clock synchronization in accordance with an embodiment of the present invention is shown. According to this embodiment, a sixth system 700 for reference clock synchronization, which synchronizes a sample clock frequency between a video and/or audio transmitter 702 and a video and/or audio receiver 704, is communicably connected 706 via, for example, a digital packet network. A clock frequency on the transmitter is similar to a clock frequency on the receiver. The transmitter includes a free-running counter that, receives a clock, counts to a maximum count and then rolls over, and sends a first value of the free-running counter to the receiver. The receiver clock frequency is equivalent to the transmitter clock frequency over an extended period of time.

The receiver 704 includes, a first module 708 that, receives the first value of the free-running counter and a first timestamp associated with the first value, receives a second value of the free-running counter and a second timestamp associated with the second value, compares the first timestamp and the second timestamp to produce a first variable, compares the first value and the second value to produce a second variable, if the second variable is greater than the first variable then the clock is slowed down, and if the second variable is less than the first variable then the clock is sped up. The receiver also includes a second module 710 that adjusts the clock speed based upon the first variable and the second variable, and a divider module 712 that adjusts to minimize a difference between the first variable and the second variable.

The described and depicted blocks or modules of the system 700 are at least one of software, hardware, and firmware, and/or the combination of at least two of software, hardware, and firmware. The transfer of data between the various blocks or modules in the system 700 occurs via at least one of a wireless protocol, a wired protocol, and a combination of a wireless protocol and a wired protocol. The steps performed in the system 700 are performed by at least one of software, hardware, and firmware, and/or the combination of software, hardware, and/or firmware. Additionally, at least one of the system 700, the transmitter 702, the receiver 704, and the described and depicted blocks or modules of the system 700, preferably form a circuit but in certain situations or applications may not.

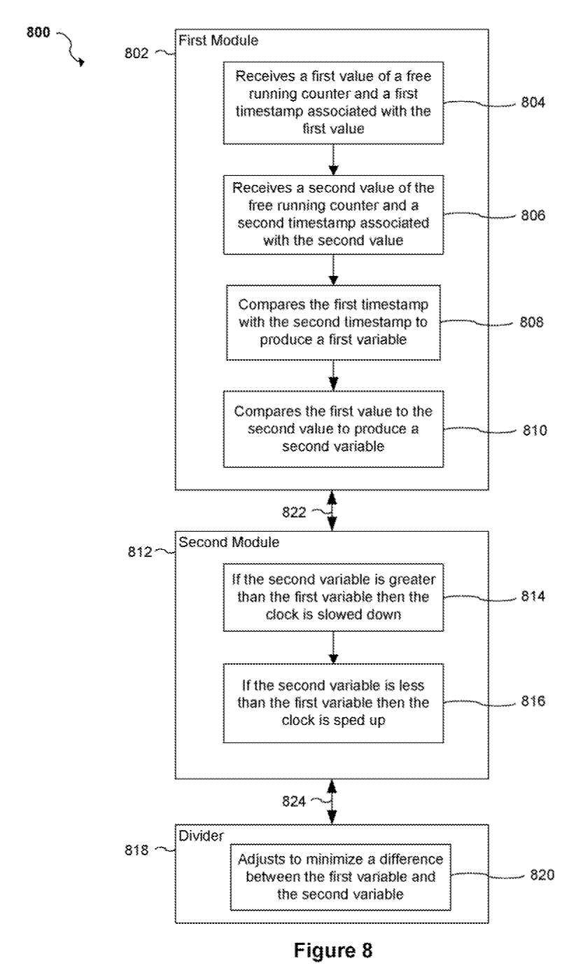

Referring to FIG. 8, a flow chart illustrating a seventh method for clock synchronization of a network in accordance with an embodiment of the present invention is shown. According to this embodiment, a seventh system 800 for reference clock synchronization synchronizes a sample clock frequency between a video and/or audio transmitter and a video and/or audio receiver. The system 800 includes a first module 802 that receives 804 a first value of the free-running counter and a first timestamp associated with the first value, receives 806 a second value of the free-running counter and a second timestamp associated with the second value, compares 808 the first timestamp and the second timestamp to produce a first variable, and compares 810 the first value and the second value to produce a second variable. The system 800 further includes a second module 812 which adjusts the clock speed. If the second variable is greater than the first variable then the clock is slowed down 814. If the second variable is less than the first variable then the clock is sped up 816, and a divider module 818 which adjusts 820 to minimize a difference between the first variable and the second variable. The first module 802 is communicably connected 822 to the second module 812 which is communicably connected 824 to the divider module 818.

The described and depicted blocks or modules of the system 800 are at least one of software, hardware, and firmware, and/or the combination of at least two of software, hardware, and firmware. The transfer of data between the various blocks or modules in the system 800 occurs via at least one of a wireless protocol, a wired protocol, and a combination of a wireless protocol and a wired protocol. The steps performed in the system 800 are performed by at least one of software, hardware, and firmware, and/or the combination of software, hardware, and/or firmware. Additionally, at least one of the system 800, the first module 802, the second module 812, the divider 818, and the described and depicted blocks or modules of the system 800, preferably form a circuit but in certain situations or applications may not.

Systems, methods, devices and computer readable media have been shown and/or described in the above embodiments for reference clock synchronization. Although the above descriptions set forth preferred embodiments, it will be understood that there is no intent to limit the present invention, but rather, it is intended to cover all modifications and alternate implementations falling within the spirit and scope of the embodiment of the present invention. For example, the various blocks or modules in the figures may be communicably connected via at least one of an Ethernet cable, a packet-based switch, a synchronous switch, an asynchronous switch, a wireless protocol, a wired protocol, and an optical protocol. Lastly, the embodiments are intended to cover capabilities and concepts whether they be via a loosely connected set of components or they be converged into one or more integrated components, devices, circuits, and/or software programs.

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A method for clock synchronization, comprising:
receiving a new transmitter timestamp based upon a transmitter clock;
determining a new transmitter timestamp delta between the new transmitter timestamp and a previous transmitter timestamp;
determining a new receiver timestamp delta between a new receiver timestamp and a previous receiver timestamp, wherein the new receiver timestamp was determined upon reception of the new transmitter timestamp and the previous receiver timestamp was determined upon reception of the previous transmitter timestamp;
comparing the new receiver timestamp delta to the new transmitter timestamp delta; and
adjusting a receiver clock to minimize a compared difference between the new receiver timestamp delta and the new transmitter timestamp delta.

2. The method of claim 1, wherein the adjusting synchronizes the receiver clock with the transmitter clock.

3. The method of claim 1, wherein the new transmitter timestamp comprises a transmitter counter value taken at a predetermined interval, and the transmitter counter value is based on a transmitter reference clock.

4. The method of claim 1, wherein the new transmitter timestamp is based on a reference clock, wherein the reference clock is selected from the group consisting of an 8 kHz reference clock, less than an 8 kHz reference clock and greater than an 8 kHz reference clock.

5. The method of claim 1, wherein the new transmitter timestamp is provided by a free running counter.

6. The method of claim 1, wherein the new transmitter timestamp is selected from the group consisting of a 24 bit timestamp, a less than 24 bit timestamp and a more than 24 bit timestamp.

7. The method of claim 1, wherein the new transmitter timestamp is packetized.

8. The method of claim 1, wherein the new receiver timestamp comprises a receiver count value based on a receiver reference clock.

9. The method of claim 1, further comprising adjusting the receiver clock to be slower when the new receiver timestamp delta is greater than the new transmitter timestamp delta.

10. The method of claim 9, wherein the receiver clock is adjusted by a percentage related to the new transmitter timestamp delta and the new receiver timestamp delta.

11. The method of claim 1, further comprising adjusting the receiver clock to be faster when the new receiver timestamp delta is less than the new transmitter timestamp delta.

12. The method of claim 11, wherein the receiver clock is adjusted by a percentage related to the new transmitter timestamp delta and the new receiver timestamp delta.

13. The method of claim 1, wherein the synchronization occurs in at least one selected from the group consisting of an optical digital packet-based network, a wired digital packet-based network and a wireless digital packet-based network.

14. A system for clock synchronization, comprising:
a receiver counter configured to determine a number of clock cycles of a receiver clock; and
a comparator communicably connected to the receiver counter, wherein the comparator is configured to:
detect a new transmitter timestamp based upon a transmitter clock;
determine a new transmitter timestamp delta between the new transmitter timestamp and a previous transmitter timestamp;
detect a new receiver timestamp provided by the receiver counter that corresponds to the reception of the new transmitter timestamp;
determine a new receiver timestamp delta between the new receiver timestamp and a previous receiver timestamp, wherein the previous receiver timestamp was determined upon reception of the previous transmitter timestamp; and
compare the new receiver timestamp delta to the new transmitter timestamp delta.

15. The system of claim 14, further comprising a terminal count generator communicably connected to the comparator, wherein the terminal count generator adjusts the receiver clock to minimize a compared difference between the new receiver timestamp delta and the new transmitter timestamp delta, and wherein the receiver clock is synchronized with the transmitter clock with the adjustment of receiver clock.

16. The system of claim 14, wherein the receiver counter is a free running counter.

17. The system of claim 14, wherein the receiver counter is configured to count to a maximum clock value and then roll over.

18. The system of claim 14, wherein the receiver clock is selected from the group consisting of a 1 kHz to 100 kHz clock, a less than 1 kHz clock and a greater than 100 kHz clock.

19. The system of claim 14, wherein the receiver counter is selected from the group consisting of a 24 bit counter, a less than 24 bit counter and a more than 24 bit counter.

20. A system for clock synchronization, comprising:
a transmitter configured to transmit a new transmitter timestamp based upon a transmitter clock;
a receiver configured to receive the new transmitter timestamp, wherein the receiver is communicably connected to the transmitter;
a receiver counter configured to determine a number of clock cycles received from a receiver clock, wherein the receiver counter is communicably connected to the receiver;
a comparator configured to:
detect a new transmitter timestamp based upon the transmitter clock;
determine a new transmitter timestamp delta between the new transmitter timestamp and a previous transmitter timestamp;
detect a new receiver timestamp provided by the receiver counter that corresponds to the reception of the new transmitter timestamp;
determine a new receiver timestamp delta between the new receiver timestamp and a previous receiver timestamp; and
compare the new receiver timestamp delta to the new transmitter timestamp delta;
wherein the comparator is communicably connected to the receiver counter; and
a terminal count generator communicably connected to the comparator, wherein the terminal count generator adjusts the receiver clock to minimize a compared difference between the new receiver timestamp delta and the new transmitter timestamp delta.

21. The system of claim 20, further comprising a transmitter packet generator configured to packetize the new transmitter timestamp, wherein the transmitter packet generator is communicably connected to the transmitter.

22. The system of claim 20, further comprising a digital packet-based network switch communicably connected to the transmitter and the receiver.

23. The system of claim 20, further comprising a receiver packet parser configured to parse the new transmitter timestamp, wherein the receiver packet parser is communicably connected to the receiver.

24. The system of claim 20, wherein the minimized compared difference between the new receiver timestamp delta and the new transmitter timestamp delta, synchronizes the receiver clock with the transmitter clock.

25. The system of claim 20, wherein the new receiver timestamp was determined upon reception of the new transmitter timestamp.

26. The system of claim 20, wherein the previous receiver timestamp was determined upon reception of the previous transmitter timestamp.

27. The system of claim 20 wherein the transmitter clock is a free running counter.

28. The system of claim 20 wherein the transmitter clock is selected from the group consisting of a 1 kHz to 100 kHz clock, a less than 1 kHz clock and a greater than 100 kHz clock.

29. A system for synchronizing a sample clock frequency between a video and/or audio transmitter and a video and/or audio receiver, comprising:
a transmitter; and
a receiver communicably connected over a digital packet network to the transmitter;
wherein a clock frequency on the transmitter is similar to a clock frequency on the receiver;
wherein the transmitter comprises:
a free-running counter configured to:
receive a clock;
count to a maximum count and then roll over; and
send a first value of the free-running counter to the receiver;
wherein the receiver comprises:
a first module configured to:
receive the first value of the free-running counter and a first timestamp associated with the first value;
receive a second value of the free-running counter and a second timestamp associated with the second value;
compare the first timestamp and the second timestamp to produce a first variable;
compare the first value and the second value to produce a second variable;
a second module configured to adjust the clock speed based upon the first variable and the second variable;
a divider adjusted to minimize a difference between the first variable and the second variable.

30. The system of claim 29, wherein second module is configured to:
slow the clock when the second variable is greater than the first variable; and
speed the clock when the second variable is less than the first variable; and

31. The system of claim 29, wherein the transmitter and the receiver are linked.

32. The system of claim 29, wherein the transmitter and the receiver are communicably connected via at least one selected from the group consisting of an Ethernet cable, a wireless protocol, a wired protocol and an optical protocol.

33. The system of claim 29, wherein the receiver clock frequency is equivalent to the transmitter clock frequency over an extended period of time.

34. A system for synchronizing a sample clock frequency between a video and/or audio transmitter and a video and/or audio receiver, comprising:
a first module configured to:
receive a first value of a free-running counter and a first timestamp associated with the first value;
receive a second value of the free-running counter and a second timestamp associated with the second value;
compare the first timestamp and the second timestamp to produce a first variable;
compare the first value and the second value to produce a second variable;
a second module configured to:
slow the clock when the second variable is greater than the first variable; and
speed the clock when the second variable is less than the first variable; and
a divider adjusted to minimize a difference between the first variable and the second variable.

35. A system for synchronizing a clock frequency between a transmitter and a receiver, comprising:
a first module configured to:
receive a first value of a counter and a first timestamp associated with the first value;
receive a second value of the counter and a second timestamp associated with the second value;
compare the first timestamp and the second timestamp to produce a first variable;
compare the first value and the second value to produce a second variable; and
a second module communicably connected to the first module, wherein the second module is configured to:
slow the clock when the second variable is greater than the first variable; and
speed the clock when the second variable is less than the first variable.

36. A method for clock synchronization, comprising:
receiving a new transmitter timestamp;
determining a new transmitter timestamp delta between the new transmitter timestamp and a previous transmitter timestamp;
determining a new receiver timestamp delta between a new receiver timestamp and a previous receiver timestamp;
comparing the new receiver timestamp delta to the new transmitter timestamp delta; and
adjusting a receiver clock based on the comparing.
